(19) United States
(12) Patent Application Publication
(10) Pub. No.: US 2026/0045859 A1
(43) Pub. Date: Feb. 12, 2026

(54) EXTERNALLY EXCITED SYNCHRONOUS MACHINE AND MOTOR VEHICLE

(71) Applicant: AUDI AG, Ingolstadt (DE)

(72) Inventor: Daniel RUPPERT, Lenting (DE)

(21) Appl. No.: 19/288,842

(22) Filed: Aug. 1, 2025

(30) Foreign Application Priority Data
Aug. 7, 2024 (DE) 102024122474.6

(51) Int. Cl. H02K 11/042; H02K 1/32; H02K 11/33; H02K 19/02

(52) U.S. Cl. CPC H02K 11/042; H02K 1/32; H02K 11/33; H02K 19/02; H02K 2211/03

(57) ABSTRACT

An externally excited synchronous machine is disclosed and may include a stator, a rotor rotatably mounted on a stator and having a rotor winding for generating a rotor magnetic field, and an inductive energy transfer circuit for energizing the rotor winding. The rotor may include a cooling volume through which a cooling fluid flows in at least one operating state of the synchronous machine. The inductive energy transfer circuit may include a stator-side primary winding, a rotor-side secondary winding, and a rectifier circuit for rectifying an alternating current provided by the secondary winding for energizing the rotor winding. The rectifier circuit may include at least one electrical structural component arranged within the cooling volume of the rotor such that the at least one electrical structural component directly contacts the cooling fluid at least in the operating state of the externally excited synchronous machine.

### BACKGROUND

### Technical Field

The present disclosure relates to an externally excited synchronous machine, specifically an externally excited synchronous machine having a rotor including a cooling volume through which a cooling fluid flows in at least one operating state of the synchronous machine. The disclosure also relates to a motor vehicle having such an externally excited synchronous machine.

### Description of the Related Art

Unlike permanently excited synchronous machines, externally excited synchronous machines do not require permanent magnets in the rotor and generate the rotor magnetic field by energizing a rotor winding of the rotor. Compared to the utilization of permanent magnets, additional degrees of freedom result in the control and design of the electric machine, which may lead to increased efficiency and performance.

The rotor winding may be energized via slip ring contacts or contactlessly via a power transfer system with an inductive rotary transformer. In the latter case, the rotor winding may be energized via a power transfer system having an inverter, an inductive rotary transformer, a rotating rectifier, and optionally a filter for smoothing the excitation current.

For high-performance electrical machines, for example when the synchronous machine is used as a drive machine for a motor vehicle, the waste heat generated during the rectification of the coil current of the rotor winding or its dissipation from the rectifier may, at least in some operating situations, limit the performance of the synchronous machine.

Publication DE102021212017A1 discloses a synchronous machine in which the structural components of a rotor-side rectifier are arranged on a printed circuit board, the back of which rests on a heat sink. A cooling fluid utilized to cool the rotor flows onto cooling fins arranged on the side of the heat sink facing away from the printed circuit board.

### BRIEF SUMMARY

An externally excited synchronous machine disclosed herein may further improve the performance of an externally excited synchronous machine, wherein at least one electrical structural component of the rectifier circuit is arranged within the cooling volume so that, at least in the operating state, the at least one electrical structural component directly contacts the cooling fluid.

Compared to indirect cooling of the structural components, the approach according to the present disclosure may achieve significantly improved thermal coupling of the at least one electrical structural component with the cooling fluid. While indirect cooling via a heat sink and a circuit board arranged thereon results in a relatively long thermal path, which significantly reduces the amount of heat that can be transferred even with a suitable choice of materials for the heat sink and circuit board, this may be avoided by the design of the synchronous machine described herein.

In some embodiments, if an insulating cooling fluid, such as, for example, oil, is utilized, which may also enable conductive sections of at least one structural component to be directly contacted by the cooling fluid, the cooling of the structural component may be significantly improved, which in turn may enable higher currents in the rotor winding and thus higher rotor fields to be utilized. Furthermore, the improved cooling may enable faster formation and deactivation of the rotor field. Thus, with an otherwise identical structural design, the synchronous machine, or a motor vehicle drive train comprising it, may achieve better performance than with indirect cooling, for example, a higher maximum and continuous performance.

The improved active cooling may also enable more efficient electronic design, thereby reducing material costs, as oversizing the electronics, which would potentially be necessary with less efficient cooling to provide thermal reserves, may no longer be necessary. The improved cooling may also increase the robustness and service life of the rotor electronics, as lower thermal gradients may be achieved under load. The direct cooling of the structural component may also eliminate the need for large heat sinks for the entire circuit board or other potentially heavy and/or bulky structural components to improve cooling. Such a configuration may reduce the weight and/or space requirements of the synchronous machine.

The cooling fluid may flow through the cooling volume at any time during operation of the externally excited synchronous machine or, for example, only in operating states in which the synchronous machine is required to deliver high power and thus has to dissipate a large amount of waste heat. The cooling fluid may be transported through the cooling volume by the operation of the synchronous machine itself and/or by a pump that is part of the synchronous machine, or by an external pump, for example, a pump of a motor vehicle comprising the synchronous machine.

The rectifier circuit may optionally comprise electrical components for filtering the rectified current in order to reduce ripple in the current supplied to the rotor winding. In some embodiments, the electrical structural component, or at least one of the electrical structural components, arranged within the cooling volume may be a rectifying structural component. Optionally, the electrical components used to filter the rectified current may also be arranged within the cooling volume, since these components may also potentially generate significant amounts of waste heat. In some embodiments, all electrical components of the rectifier circuit, including the components used for filtering, may be arranged within the cooling volume.

A pump for transporting the cooling fluid and/or a heat exchanger for controlling the temperature of the cooling fluid may, for example, be provided on the stator side or arranged as separate components, such as stationary relative to the stator. A fluid inlet and/or outlet may be embodied in a conventional manner as fluid guides between mutually rotating components, for example, by way of a labyrinth seal or similar. Alternatively, the entire cooling circuit may be integrated into the rotor.

The electrical structural component, or at least one of the electrical structural components, may be a semiconductor switch or a diode. Such a configuration enables direct cooling, such as for those components that actively or passively rectify the current. Thus, in some embodiments, structural components, which increase in temperature, particularly during rectification, may be directly contacted by the cooling fluid and thus directly cooled.

At least one electrical connection and/or a conductor track contacting the electrical connection of a printed circuit board carrying the respective structural component may be directly adjacent to the cooling volume and thus may directly contact the cooling fluid in the operating state. Since the electrical connections or the conductor tracks contacting the structural components typically have high thermal conductivity, particularly efficient dissipation of waste heat from the structural component may be possible.

The cooling fluid may be an oil and/or electrically insulating. If a conductive cooling fluid were utilized, the contact of the cooling fluid with the respective structural component would need to be limited to insulating sections of the structural component, for example its housing, and/or the respective structural component would need to be ensured that only electrically conducting areas at the same potential are contacted by the cooling fluid or a contiguous partial volume of the cooling fluid. By utilizing an electrically insulating cooling fluid, conducting components at different potentials may also be contacted by the cooling fluid without causing a short circuit. Oil has proven to be a particularly suitable cooling fluid because it is not only electrically insulating, but also has a high heat capacity and may also have a lubricating effect, for example, if other components of the synchronous machine are to be cooled via the cooling volume.

The cooling volume may be configured, at least in that section in which the at least one structural component is arranged, as a cooling channel which is configured to guide the cooling fluid from one or more cooling fluid inlets to one or more cooling fluid outlets and which, apart from the at least one cooling fluid inlet and the at least one cooling fluid outlet, is fluid-tight.

For example, the cooling volume may be part of a cooling system which is closed at least within the rotor, and which may be connected to a stator-side part of the cooling system via a respective cooling fluid inlet and outlet. However, at least parts of the cooling fluid outlets may guide cooling fluid into a free space surrounding the rotor, for example, to cool the rotor coil in the area of the air gap of the synchronous machine.

The cooling volume may be a cooling channel or comprise a cooling channel which extends along the rotor shaft in the axial direction of the synchronous machine. In some embodiments, the cooling channel may extend through the rotor shaft such that the cooling fluid is supplied to a first side of the rotor winding in the axial direction via a stator-side cooling fluid inlet and is discharged on a second side of the rotor winding in the axial direction via a stator-side cooling fluid outlet. However, alternatively, the cooling fluid may be redirected within the rotor shaft, so that, for example, coaxial cooling channels which guide the cooling fluid in different directions may be utilized to arrange the stator-side cooling fluid inlet and outlet on one side of the rotor in the axial direction.

The at least one electrical component of the rectifier circuit or the entire rectifier circuit may be arranged in the cooling channel, which may extend along the rotor shaft in the axial direction of the synchronous machine. In some embodiments, a printed circuit board carrying the electrical components or the rectifier circuit may extend parallel to the axial direction. To better adapt such a printed circuit board to the channel geometry of the cooling channel, a curved or flexibly bendable printed circuit board may be used.

Instead of a printed circuit board, the electrical structural components may also be carried directly by a wall of such a cooling channel. If coaxial cooling channels are utilized to guide the cooling fluid in different directions, a partition wall separating the cooling channels, for example, may carry the at least one electrical structural component.

The integration of the at least one electrical structural component of the rectifier circuit into the cooling channel may be installation space-efficient, since a known cooling channel geometry, which may also be used for other cooling tasks, does not need to be modified, or at most only slightly, to achieve cooling of the structural component. Separate cooling channels for supplying the cooling fluid to the structural components are therefore not required. Furthermore, a compact rotor and thus a compact synchronous machine may be achieved compared to a printed circuit board carrying the rectifier circuit running parallel to the radial direction of the rotor, for example.

A respective section of a boundary surface delimiting the cooling volume may be formed by the secondary winding and/or the primary winding in order to cool the secondary winding and/or the primary winding in the operating state by way of the cooling fluid. Such a configuration enables active cooling of the primary and/or secondary winding to be implemented with little effort. Active cooling of the respective winding may enable higher power transfer for a given winding design. Furthermore, due to the active cooling, a given power transfer may be achieved, for example, with a smaller wire cross-section of the winding and thus with less material expenditure than would be required if such active cooling were not present.

The rectifier circuit may be configured for actively rectifying an alternating current provided by the secondary winding by a plurality of semiconductor switches, wherein a control device of the synchronous machine controlling the semiconductor switches may be configured to transfer power from the primary winding to the secondary winding in a first operating state of the synchronous machine and to transfer power from the secondary winding to the primary winding in a second operating state of the synchronous machine.

Operation in the second operating state may be expedient, for example, to recover the energy used to generate the rotor field when the rotor field is reduced, for example, when the synchronous machine is no longer in operation, and/or to be able to reduce the current flow in the rotor winding particularly quickly, for example, in the event of an accident involving a motor vehicle utilizing the synchronous machine. The rectifier circuit may therefore also be operated as an inverter or, more generally, as a converter. Such a configuration may enable a direct current flowing through the rotor winding to maintain the rotor field to be inverted and transferred to the primary winding via the secondary winding.

The above-described active cooling of the at least one active structural component of the rectifier circuit or of the converter circuit forming the rectifier circuit by direct contact of the at least one electrical structural component with the cooling fluid may occur in the first and/or second operating state.

In addition to the externally excited synchronous machine, the present disclosure relates to a motor vehicle comprising an externally excited synchronous machine described herein. Since externally excited synchronous machines, when intended for utilization as drive machines in a motor vehicle, are often required to have particularly high power densities, the configuration of the externally excited synchronous machine for motor vehicles may be particularly advantageous.

In some embodiments, the motor vehicle may comprise additional components of a cooling fluid circuit comprising the cooling volume and formed separately from the synchronous machine, for example, at least one pump for transporting the cooling fluid and/or at least one heat exchanger for controlling the temperature of the cooling fluid. Alternatively, these components may be at least partially integrated into the synchronous machine itself, for example, into the stator.

### BRIEF DESCRIPTION OF THE SEVERAL VIEWS OF THE DRAWINGS

FIG. 1 shows a detailed view of an exemplary embodiment of an externally excited synchronous machine according to the present disclosure.

FIG. 2 shows a schematic view of an exemplary embodiment of a motor vehicle according to the present disclosure.

### DETAILED DESCRIPTION

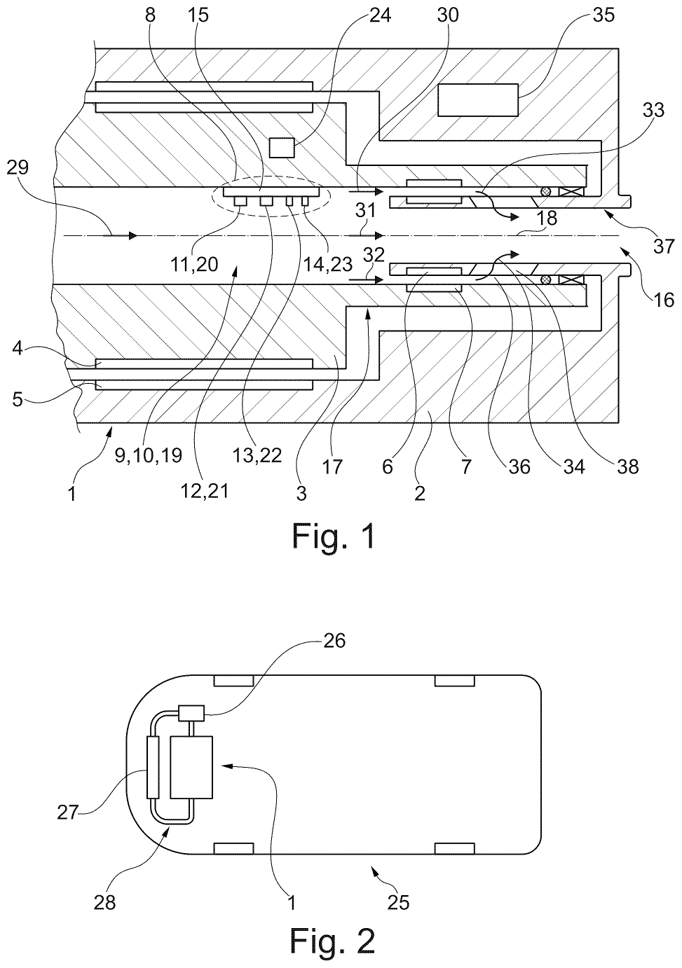

FIG. 1 shows a detailed view of an externally excited synchronous machine 1 having a rotor 3 rotatably mounted on a stator 2. Rotor 3 may have a rotor winding 4 for generating a rotor magnetic field, wherein the energy required to energize rotor winding 4 may be transferred from stator 2 to rotor 3 by an inductive energy transfer circuit. For this purpose, the energy transfer circuit may comprise a stator-side primary winding 6, an inverter 35 for energizing primary winding 6, a rotor-side secondary winding 7, and a rectifier circuit 8 for rectifying an alternating current provided by secondary winding 7 to provide a direct current for the rotor winding 4.

The removal of heat generated during the rectification of the alternating current provided via secondary winding 7 may be a limiting factor for the performance of the synchronous machine. Therefore, electrical structural components 11, 12, 13, 14 of rectifier circuit 8 in synchronous machine 1 may be cooled by arranging electrical structural components 11, 12, 13, 14 within a cooling volume 9 through which a cooling fluid 10 may flow in at least one operating state of synchronous machine 1, as schematically illustrated in FIG. 1 by arrows 29, 30, 31, 32, 33, 34. As a result, during operation of synchronous machine 1, structural components 11, 12, 13, 14 may be directly contacted by passing cooling fluid 10 and may be cooled as a result.

In the example embodiment illustrated in FIG. 1, the entire rectifier circuit 8, including printed circuit board 15 carrying electrical structural components 11, 12, 13, 14, may be located in a cooling channel 19 of cooling volume 9, which may extend in the axial direction of synchronous machine 1 and thus parallel to rotational axis 18 of rotor 3. In the example, cooling fluid 10 may be supplied to cooling channel 19 via a cooling fluid inlet located to the left outside the image arca and may flow out of the synchronous machine via cooling fluid outlet 16, illustrated as a flange by way of example. In the example, apart from the cooling fluid inlet and cooling fluid outlet 16, cooling channel 19 may be sealed in a fluid-tight manner. In alternative embodiments, however, a portion of the cooling fluid may be guided radially outward in the region of rotor winding 4 in order to cool the rotor winding and/or, after exiting into the air gap, stator winding 5.

Two semiconductor switches 20, 21 and two diodes 22, 23 are, by way of example, illustrated as cooled electrical structural components 11, 12, 13, 14. In the example, rectification by a half-bridge may be implemented by the components shown, with the positive and negative branches of the half-bridge each comprising one of semiconductor switches 20, 21 and, connected in parallel thereto, one of diodes 22, 23 as a freewheeling diode. In the example shown, semiconductor switches 20, 21 may be controlled by a rotor-side control device 24. For this purpose, control device 24 may be configured such that the control device 24 enables bidirectional energy transfer, i.e., the control device 24 may also feed energy back from secondary coil 6 to primary coil 7.

In some embodiments, electrical structural components of rectifier circuit 8 (not shown), which are used to filter the rectified current to reduce the current ripple, for example at least one capacitor and/or resistor, may be cooled by direct contact with cooling fluid 10.

In some embodiments, cooling fluid 10 may be an electrically insulating oil. Such embodiments may enable the electrical connections of structural components 11, 12, 13, 14 and the conductor tracks of circuit board 15 that contact these electrical connections to be directly adjacent to cooling volume 9 and to directly contact cooling fluid 10 without any risk of short circuit.

In some embodiments, the cooling volume may also be directly adjacent to primary winding 6 and secondary winding 7 in order to cool the windings utilized for inductive current transfer. For this purpose, in some embodiments, a portion of the cooling fluid may flow through an outer annular channel 36, as indicated by arrows 30, 32, which may be delimited in a central section by the surfaces of primary winding 6 and secondary winding 7. After flowing over these surfaces, cooling fluid 10 may be guided through openings 38 of stator-side inner tube 37, where the rotor shaft is mounted, as illustrated in FIG. 1 by arrows 33, 34, back into and through cooling channel 19 to cooling fluid outlet 16.

FIG. 2 shows, by way of example, the utilization of externally excited synchronous machine 1 explained above with reference to FIG. 1 in a motor vehicle 25, wherein synchronous machine 1 is used in the example as a drive unit of motor vehicle 25. Motor vehicle 25 may comprise, in addition to synchronous machine 1, which forms cooling volume 9, further components of the closed cooling fluid circuit 28, which, in the example, may be formed separately from synchronous machine 1.

In some embodiments, the circulation of cooling fluid 10 may be carried out by a pump 26. For temperature control, cooling fluid 10 may be guided through a heat exchanger 27 of motor vehicle 25, which cools the vehicle by exchanging heat with ambient air, which is guided through the heat exchanger 27, for example, by the airstream and/or by way of an additional fan.

German patent application no. 102024122474.6, filed Aug. 7, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An externally excited synchronous machine comprising:
a stator;
a rotor rotatably mounted on the stator, the rotor having a rotor winding for generating a rotor magnetic field and a cooling volume through which a cooling fluid flows in at least one operating state of the synchronous machine; and
an inductive energy transfer circuit for energizing the rotor winding, the inductive energy transfer circuit having a stator-side primary winding, a rotor-side secondary winding, and a rectifier circuit for rectifying an alternating current provided by the secondary winding for energizing the rotor winding, the rectifier circuit including at least one electrical structural component arranged within the cooling volume of the rotor such that the at least one electrical structural component directly contacts the cooling fluid at least in the operating state of the externally excited synchronous machine.

2. The externally excited synchronous machine according to claim 1, wherein one or more electrical structural components of the at least one electrical structural components is a semiconductor switch or a diode.

3. The externally excited synchronous machine according to claim 1, further comprising at least one electrical connection and/or a conductor track,
wherein the at least one electrical connection and/or the conductor track contacts the electrical connection of a printed circuit board, the printed circuit board carrying a respective electrical structural component directly adjacent to the cooling volume, and
wherein the respective electrical structural component directly contacts the cooling fluid in the operating state.

4. The externally excited synchronous machine according to claim 1, wherein the cooling fluid is an oil and/or is electrically insulating.

5. The externally excited synchronous machine according to claim 1, wherein the cooling volume is configured as a cooling channel configured to guide the cooling fluid from one or more cooling fluid inlets to one or more cooling fluid outlets,
wherein the cooling channel is fluid tight at least in a section in which the at least one electrical structural component is arranged apart from the at least one cooling fluid inlet and the at least one cooling fluid outlet.

6. The externally excited synchronous machine according to claim 1, wherein the cooling volume comprises a cooling channel extending along a rotor shaft in an axial direction of the externally excited synchronous machine.

7. The externally excited synchronous machine according to claim 6, wherein at least one electrical component of the rectifier circuit is arranged in the cooling channel extending along the rotor shaft in the axial direction of the externally excited synchronous machine.

8. The externally excited synchronous machine according to claim 7, wherein the entire rectifier circuit is arranged in the cooling channel extending along the rotor shaft in the axial direction of the externally excited synchronous machine.

9. The externally excited synchronous machine according to claim 6, wherein the cooling volume is a cooling channel extending along a rotor shaft in an axial direction of the externally excited synchronous machine.

10. The externally excited synchronous machine according to claim 1, wherein a section of a boundary surface delimiting the cooling volume is formed by at least one of the secondary winding and by the primary winding and is configured to cool the at least one of the secondary winding and the primary winding in the operating state by way of the cooling fluid.

11. The externally excited synchronous machine according to claim 1, wherein the rectifier circuit is configured for active rectification of an alternating current provided by the secondary winding by way of a plurality of semiconductor switches,
wherein a control device of the externally excited synchronous machine controls the semiconductor switches and is configured to transfer power from a primary winding to the secondary winding in a first operating state of the operating state of the externally excited synchronous machine and to transfer power from the secondary winding to the primary winding in a second operating state of the operating state of the externally excited synchronous machine.

12. A motor vehicle comprising:
an externally excited synchronous machine including:
a stator;
a rotor rotatably mounted on the stator, the rotor having a rotor winding for generating a rotor magnetic field and a cooling volume through which a cooling fluid flows in at least one operating state of the synchronous machine;
an inductive energy transfer circuit for energizing the rotor winding, the energy transfer circuit having a stator-side primary winding, a rotor-side secondary winding, and a rectifier circuit for rectifying an alternating current provided by the secondary winding for energizing the rotor winding, the rectifier circuit including at least one electrical structural component arranged within the cooling volume of the rotor such that the at least one electrical structural component directly contacts the cooling fluid at least in the operating state of the externally excited synchronous machine.
